(19) United States
(12) Patent Application Publication
(10) Pub. No.: US 2018/0181819 A1
(43) Pub. Date: Jun. 28, 2018

(54) DEMARCATION LINE RECOGNITION DEVICE

(71) Applicant: DENSO CORPORATION, Kariya-city (JP)

(72) Inventors: Taiki Kawano, Nishio-city (JP); Naoki Kawasaki, Nishio-city (JP); Naoki Nitanda, Kariya-city (JP); Kenta Hoki, Kariya-city (JP)

(21) Appl. No.: 15/845,416

(22) Filed: Dec. 18, 2017

(30) Foreign Application Priority Data
Dec. 22, 2016 (JP) 2016-249395

(51) Int. Cl. G06K 9/00; B60W 30/12; B60R 1/00; B60R 11/04

(52) U.S. Cl. CPC G06K 9/00798; B60W 30/12; B60R 2300/804; B60R 11/04; B60R 1/00

(57) ABSTRACT

The demarcation line recognition device determines the line type and line color of the extracted candidate line, and the presence or absence of an influence of backlight, and determines whether the extracted candidate line constitutes a part of a multiple line. The demarcation line recognition device selects a candidate line corresponding to a demarcation line from extracted candidate lines, using the line type and line color determined, and the determination result of the multiple line determination, and according to the rules of the driving region. When a candidate line determined to be under the influence of backlight constitutes a part of a multiple line, the demarcation line recognition device compares the color information of the candidate lines constituting that multiple line with each other and re-determines the line color of the candidate line determined to be under the influence of backlight.

### CROSS-REFERENCE TO RELATED APPLICATION

This application is based on and claims the benefit of priority from earlier Japanese Patent Application No. 2016-249395 filed Dec. 22, 2016, the description of which is incorporated herein by reference.

### BACKGROUND

### Technical Field

The present disclosure relates to a technique for recognizing lane demarcation lines.

### Related Art

The colors of demarcation lines defining lanes include yellow, blue, and so on besides white. The line color is important information for recognizing demarcation lines. In view of this, the lane marking recognition device disclosed in JP 2007-18154 A extracts each specific color corresponding to the line color from a captured color image, and generates an extracted image in which the demarcation line of each specific color can be easily detected. The lane marking recognition device then combines the generated extracted images of the specific colors and detects the lane demarcation line of each specific color from the combined image.

In a scene with strong reflected light due to backlighting, a yellow demarcation line looks like a white demarcation line which is difficult to distinguish with human eyes. In such a scene, a part of the color image that is essentially yellow appears to be white. Therefore, extracting the part that is essentially yellow as yellow data from the color image is not possible. That is, the color of a demarcation line may not be accurately determined in a backlit scene by the lane marking recognition device mentioned above. Thus, there is concern with the lane marking recognition device that the accuracy of lane estimation may decrease due to incorrect recognition of a demarcation line. It is not only the color of yellow demarcation lines that is difficult to determine in a backlight scene as described above. The difficulty is common to demarcation lines of colors other than white.

### SUMMARY

The present disclosure provides a technique capable of accurately recognizing a demarcation line by accurately determining the candidate color of the demarcation line even in a backlit scene.

An aspect of the technique of the present disclosure is a demarcation line recognition device for estimating a lane on which a vehicle travels from a color road surface image captured by a camera. The demarcation line recognition device estimates a lane on which a vehicle travels from a color road surface image captured by a camera. The demarcation line recognition device includes a candidate line extraction unit, a line feature determination unit, a multiple line determination unit, a candidate selection unit, a lane estimation unit, and an output unit.

The candidate line extraction unit is configured to extract a candidate line which is a candidate for a demarcation line demarcating the lane from the road surface image. The line feature determination unit is configured to determine a line type and a line color of the candidate line extracted by the candidate line extracting unit, and presence or absence of an influence of backlight, the backlight being light from a direction opposing the camera. The multiple line determination unit is configured to determine whether the candidate line extracted by the candidate line extracting unit constitutes a part of a multiple line. The candidate selection unit selects a candidate line corresponding to a demarcation line from the candidate lines extracted by the candidate line extraction unit, according to the rules of the driving region. Specifically, the candidate selection unit is configured to select a candidate line according to the rules of the driving region, using the line type and line color determined by the line feature determination unit, and the determination result from the multiple line determination unit. The lane estimation unit is configured to recognize the candidate line selected by the candidate selection unit and estimate the shape of the lane. The output unit is configured to output the estimation result estimated by the lane estimation unit. Further, when a candidate line determined to be under the influence of backlight constitutes a part of a multiple line, the line feature determination unit re-determines the line color of the candidate line as follows. Specifically, the line feature determination unit is configured to compare the color information of the candidate lines constituting the multiple line with each other and re-determines the line color of the candidate line determined to be under the influence of backlight.

According to the present disclosure, the demarcation line recognition device extracts a candidate line from a color road surface image, and determines the line type and line color of the extracted candidate line, and the presence or absence of an influence of backlight. In addition, the demarcation line recognition device determines whether the candidate line constitutes a part of a multiple line. The line type, the line color, and the structure of a multiple line to be recognized as a demarcation line differ depending on the rules in the driving region. Focusing on this point, the demarcation line recognition device selects a candidate line corresponding to a demarcation line according to the rules of the driving region, using the determined line type and line color, and the result of multiple line determination. The demarcation line recognition device recognizes the selected candidate line, estimates the shape of the lane, and outputs the estimation result.

When a candidate line is affected by backlight, white characteristics appear in the color information of the candidate line of a specific color other than white. This reduces the appearance ratio of the characteristics of the specific color. Therefore, determining the color based on a single candidate line is difficult. When the candidate line is included in a multiple line, and the color determination of the candidate line is incorrect, a wrong candidate line may be erroneously selected. However, even when the appearance ratio of the features of a specific color becomes small in the color information of the candidate line of the specific color as described above, as compared with the color information of candidate lines with other colors, the appearance ratio of the features of the specific color is large relative to those of other colors. Thus, when the candidate line is affected by backlight, the color of the candidate line can be determined with high accuracy by comparing the color information of a plurality of candidate lines. Accordingly, when a candidate line under the influence of backlight constitutes a part of a multiple line, the demarcation line recognition device according to the present disclosure compares the color information of candidate lines constituting the multiple line with each other and re-determines the line color of the candidate line. Thus, the demarcation line recognition device according to the present disclosure can accurately determine the color of the candidate line and accurately estimate the lane even in a backlit scene.

The reference numbers in parentheses above and in the claims merely indicate the correspondence with the specific means described with respect to the embodiment described below as one aspect of the technique of the present disclosure. Thus, these reference numbers do not limit the technical scope of the present disclosure.

### BRIEF DESCRIPTION OF THE DRAWINGS

In the accompanying drawings:

FIG. 1 is a diagram showing the position where the in-vehicle camera is mounted;

FIG. 2 is a block diagram showing the configuration of a demarcation line recognition device;

FIG. 3 is a flowchart showing the procedure for estimating the shape of a lane based on the extracted candidate lines;

FIG. 4 is a schematic diagram of a zone under construction in Europe;

FIG. 5 is a schematic diagram of a zone that is temporarily in service in Japan;

FIG. 6 is a schematic diagram of a zone where straddling a line is prohibited in Japan;

FIG. 7 is a schematic diagram showing an image of a scene in which a yellow line looks like a white line due to reflection of backlight; and

FIG. 8 is a diagram showing the determined line type, line color, and color component values of each demarcation line in the image shown in FIG. 7.

### DETAILED DESCRIPTION OF THE PREFERRED EMBODIMENTS

An embodiment for implementing the technique of the present disclosure will be described with reference to the drawings.

<1. Configuration>

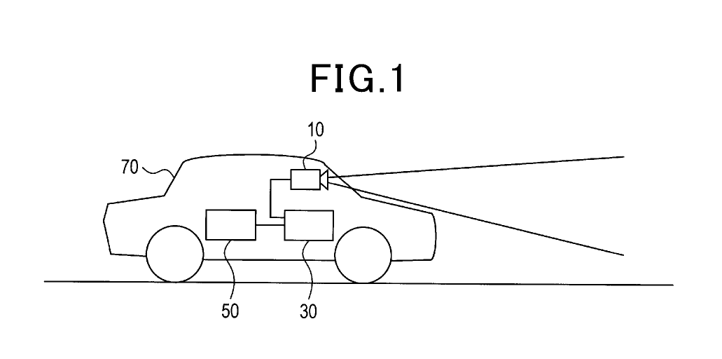

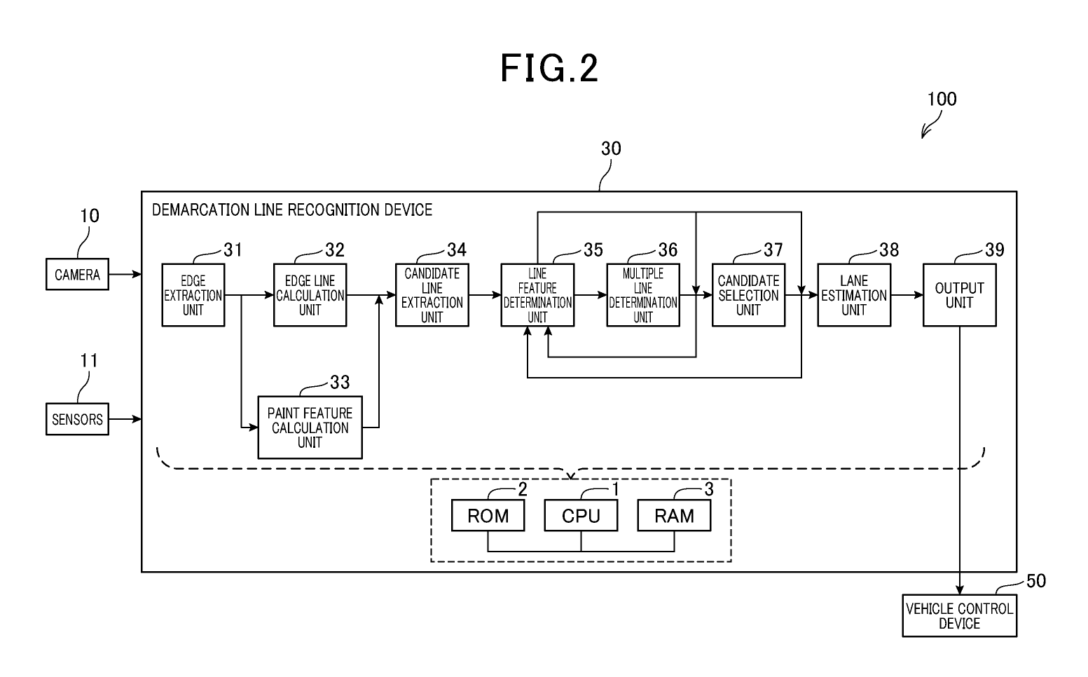

A demarcation line recognition device 30 according to the present embodiment is applied to, for example, a driving support system 100 as follows. The configuration of the driving support system 100 will be described with reference to FIGS. 1 and 2. The driving support system 100 according to the present embodiment includes an in-vehicle camera 10, sensors 11, a vehicle control device 50, and a demarcation line recognition device 30. The in-vehicle camera 10, sensors 11, and vehicle control device 50 are connected to the demarcation line recognition device 30 via signal lines. The demarcation line recognition device 30 is installed in a vehicle 70 that recognizes the demarcation lines and estimates the shape of the lane. In addition, demarcation lines are white lines, yellow lines, blue lines, and the like drawn on the road surface so as to define a lane on the road.

As shown in FIG. 1, the in-vehicle camera 10 is mounted so that a predetermined area of the road surface ahead of the vehicle is set as an imaging area. For example, the in-vehicle camera 10 may be mounted to the rearview mirror. The in-vehicle camera 10 repeatedly captures an image of the imaging area at predetermined intervals (for example, at 1/15 second intervals). Then, the in-vehicle camera 10 converts the obtained captured color image to be a digital signal, and then outputs to the demarcation line recognition device 30.

The sensors 11 are various sensors for measuring the state of the vehicle 70. The sensors 11 include, for example, a speed sensor that measures the speed of the vehicle 70, a yaw rate sensor that measures the yaw rate of the vehicle 70, and the like. The sensors 11 repeatedly measure the state of the vehicle 70 at predetermined intervals. Then, the sensors 11 output the obtained measurement results to the demarcation line recognition device 30.

The vehicle control device 50 is configured as, for example, an ECU (Electronic Control Unit). Specifically, the vehicle control device 50 is configured as a microcomputer including CPU, ROM, RAM, I/O, and a semiconductor memory such as a flash memory. The vehicle control device 50 is configured such that the CPU executes the programs stored in the non-transitory computer-readable storage medium. The vehicle control device 50 thereby executes driving support such as alert output control or driving control based on, for example, the estimation result of the demarcation line recognition device 30. The alert output control is a control for executing an alert output when the vehicle 70 is about to deviate from the lane. The driving control is the steering control or the braking control of the vehicle 70 executed such that the vehicle 70 travels inside the lane.

The demarcation line recognition device 30 is configured as, for example, an ECU. Specifically, the demarcation line recognition device 30 is configured as a microcomputer including CPU 1, ROM 2, RAM 3, I/O, and a semiconductor memory such as a flash memory. The demarcation line recognition device 30 is configured such that the CPU 1 executes a program stored in the non-transitory computer-readable storage medium. The demarcation line recognition device 30 thereby realizes each function shown in FIG. 2. In the present embodiment, the semiconductor memory corresponds to the non-transitory computer-readable storage medium for storing programs. Further, in the demarcation line recognition device 30, a procedure (method) defined in a program is executed by executing the program. The number of microcomputers constituting the demarcation line recognition device 30 is not limited to one. The number of microcomputers may be two or more.

As shown in FIG. 2, the demarcation line recognition device 30 includes an edge extraction unit 31, an edge line calculation unit 32, and a paint feature calculation unit 33. Further, the demarcation line recognition device 30 includes a candidate line extraction unit 34, a line feature determination unit 35, a multiple line determination unit 36, a candidate selection unit 37, a lane estimation unit 38, and an output unit 39. The way of realizing these functions (constituent elements) is not limited to methods using software such as the program described above. Other methods include, for example, the elements of a part or all of the functions may be realized by using hardware combining logic circuits, analog circuits.

The edge extraction unit 31 acquires a road surface image captured by the in-vehicle camera 10. Then, the edge extraction unit 31 extracts edge points from the acquired road surface image. Edge points are pixels with large changes in the luminance value. The road surface image is a color image having a red component value (hereinafter referred to as “R value”), a green component value (hereinafter referred to as “G value”), and a blue component value (hereinafter referred to as “B value”) as a data for each pixel. That is, the road surface image is a color image having an RGB color space. The edge extraction unit 31 searches for pixels where the amount of change in the luminance value is equal to or larger than the threshold in the horizontal direction from the left end to the right end of the image. As a result, the edge extraction unit 31 extracts up edge points and down edge points. The up edge point is a luminance rising point which changes from a low luminance value to a high luminance value. The down edge point is a luminance falling point which changes from a high luminance value to a low luminance value.

The edge line calculation unit 32 applies the Hough transform to the edge points extracted by the edge extraction unit 31 to extract line components. Then, the edge line calculation unit 32 calculates edge lines including the extracted line components. The edge line calculation unit 32 thus calculates edge lines comprised of up edge points and edge lines comprised of down edge points.

The paint feature calculation unit 33 extracts a rectangular region formed by edge points as a paint block. Specifically, the paint feature calculation unit 33 extracts, as a paint block, a region that is surrounded with an up edge point at its left side and a down edge point at its right side, in which the distance between edge points in the traveling direction of the vehicle 70 is equal to or smaller than a preset interval threshold. The paint feature calculation unit 33 calculates the length and width of the extracted paint block. The length of the paint block is the length in the traveling direction of the vehicle 70. The width of the paint block is the interval between the up edge point and the down edge point. The interval threshold is shorter than the interval between the line segments of a broken line which is a common demarcation line. In addition, the interval threshold is defined such that edge points belong to the same line segment when the interval between the edge points is less than the interval threshold.

The candidate line extraction unit 34 selects, from the edge lines calculated by the edge line calculation unit 32, a pair of edge lines including a left edge line comprised of up edge points and a right edge line comprised of down edge points. At this time, the candidate line extraction unit 34 selects the pair of edge lines that has a width that is likely to be a demarcation line, based on the width of the paint block calculated by the paint feature calculation unit 33. Then, the candidate line extraction unit 34 extracts a rectangular line defined by the selected pair of edge lines as a candidate line.

The line feature determination unit 35 determines the line type and line color of the candidate line extracted by the candidate line extraction unit 34, and the presence or absence of an influence of backlight. Here, light from a direction opposing the in-vehicle camera 10 is regarded as backlight. The light source of backlight may be, for example, sunlight or headlights of an oncoming vehicle. The multiple line determination unit 36 determines whether the candidate line extracted by the candidate line extraction unit 34 constitutes a part of a multiple line. The candidate selection unit 37 selects a candidate line for a demarcation line from the candidate lines extracted by the candidate line extraction unit 34, using the determination result of the line feature determination unit 35 and the multiple line determination unit 36.

The lane estimation unit 38 recognizes the candidate line selected by the candidate selection unit 37 and estimates the shape of the lane on which the vehicle 70 travels. The output unit 39 outputs the estimation result estimated by the lane estimation unit 38 to the vehicle control device 50. The processes carried out by the line feature determination unit 35, the multiple line determination unit 36, the candidate selection unit 37, the lane estimation unit 38, and the output unit 39 will be described later in detail.

<2. Lane Estimation Process>

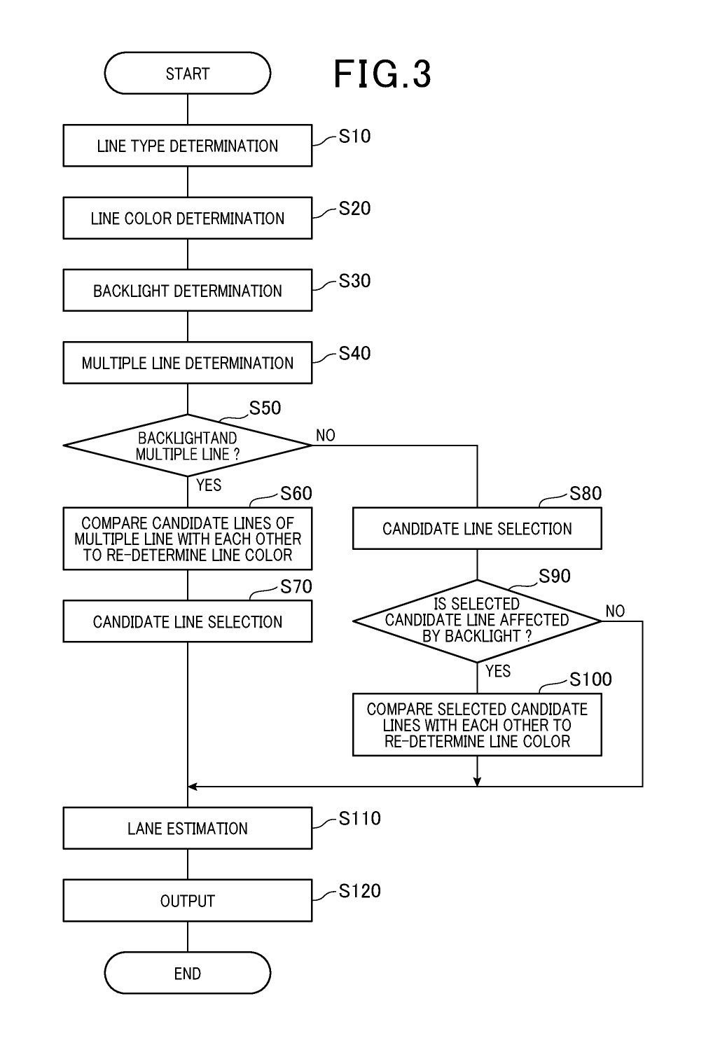

Next, the procedure of the lane estimation process carried out by the demarcation line recognition device 30 will be described with reference to the flowchart shown in FIG. 3. This procedure is executed every time a candidate line is extracted by the candidate line extraction unit 34.

The demarcation line recognition device 30 determines the line type (the kind of line) of the candidate line from the distribution of the edge points belonging to the candidate line in the road surface image (step S10). The line type of the candidate line may be, for example, a solid or broken demarcation line, or an auxiliary broken line drawn inside the demarcation line. Normally, the length of the line segments and the interval between the line segments are different between a broken demarcation line and a broken auxiliary line. Thus, the line type can be determined based on the distribution of the edge points in the road surface image.

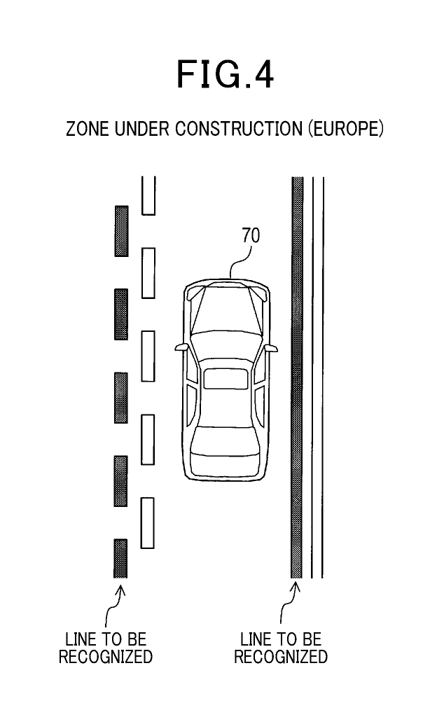

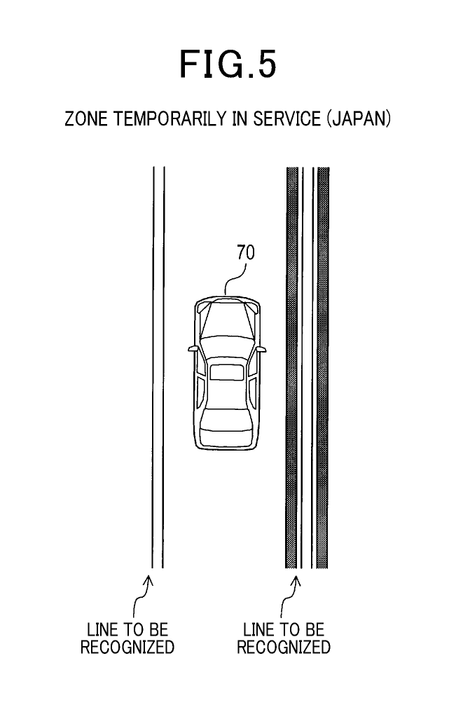

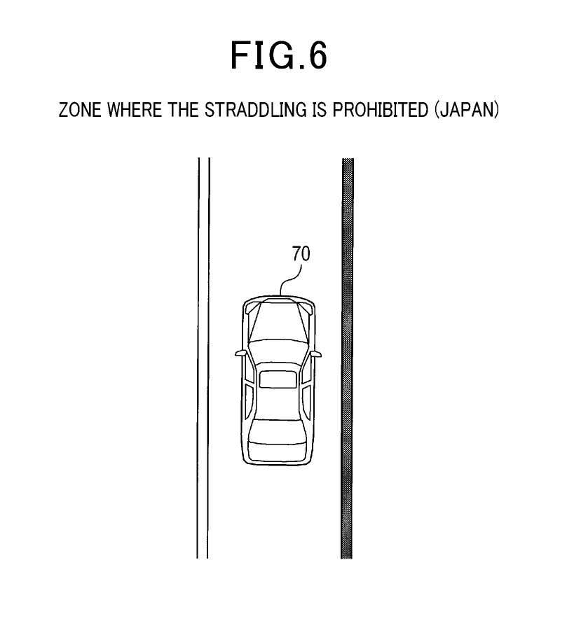

Next, the demarcation line recognition device 30 determines the line color (the color of the line) of the candidate line (step S20). The color of the demarcation line has a specific meaning determined by the rules of the driving region. FIGS. 4 to 6 show examples in which yellow demarcation lines (hereinafter referred to as “yellow lines”) having different meanings are drawn on the road surface. In FIGS. 4 to 6, hatched lines indicate yellow lines, and unhatched lines indicate white demarcation lines (hereinafter referred to as “white lines”). FIG. 4 shows a zone under construction in Europe. In Europe, a lane drawn with yellow lines over white lines indicates a temporary lane. In this case, the yellow lines must be recognized as the demarcation lines and not the white lines. FIG. 5 shows a zone that is temporarily in service in Japan. In Japan, a multiple line with yellow lines sandwiching a white line indicates a section that is in service with a provisional structure, and crossing this multiple line means entering the opposite lane. In this case, the yellow line closest to the vehicle 70 must be recognized as the demarcation line. FIG. 6 shows a zone where straddling a line is prohibited in Japan. In this case, one must drive so that the vehicle 70 stays within the yellow line.

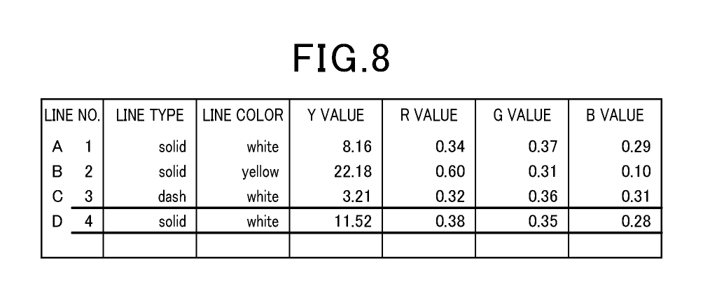

Specifically, the line feature determination unit 35 determines the line color of the candidate line based on the relationship (see FIG. 8) of the magnitudes of the RGB component values of the candidate line. For example, in the case of white, the differences between the R value, the G value, and the B value are small, and the three component values are substantially the same. Thus, when all of the differences between the R value, the G value, and the B value are less than the preset difference threshold, the line feature determination unit 35 determines that the line color is white. On the other hand, when the color is not white, the magnitudes of the R value, the G value, and the B value have a given relationship depending on the color. For example, in the case of yellow, the relation is R value>G value >B value, or R value>G value and R value >B value. Thus, when any one of the differences between the R value, the G value, and the B value is greater than or equal to the difference threshold, the line feature determination unit 35 determines, based on the relationship of the magnitudes of the R value, the G value, and the B value, whether the line color is yellow or blue.

Next, the demarcation line recognition device 30 determines whether or not the candidate line is affected by backlighting based on at least one of the luminance value of the candidate line and the position of the light source (the direction of the light source) with respect to the in-vehicle camera 10 (step S30). Specifically, the demarcation line recognition device 30 determines as follows. For example, when the candidate line is affected by backlighting, the luminance value of the candidate line becomes very high. Thus, when the luminance value of the candidate line is larger than a preset luminance threshold, the demarcation line recognition device 30 determines that the candidate line is affected by backlighting. The luminance value of the candidate line may be, for example, the average luminance value of the candidate line. Further, the luminance threshold may be set to such a large luminance value that cannot be obtained in situations where there is no influence of backlighting. In addition, when the position of the light source is at a position opposing the in-vehicle camera 10, the demarcation line recognition device 30 determines that the candidate line is affected by backlighting. Note that the position of the light source (the direction of the light source) such as the sun or headlights of an oncoming vehicle may be determined by calculating the part where the luminance value is very large in the image as the light source. In addition, the position of the sun (the direction of the sun) can be calculated from the position of the vehicle 70 upon image capturing and the date and time.

Next, the demarcation line recognition device 30 determines whether the candidate line constitutes a part of a multiple line (step S40). Specifically, the demarcation line recognition device 30 determines as follows. When a plurality of candidate lines are extracted from a preset determination range in the horizontal direction of the image, the demarcation line recognition device 30 determines that the plurality of candidate lines each constitute a multiple line. Further, when only one candidate line is extracted from the preset determination range, the demarcation line recognition device 30 determines that the candidate line does not constitute a part of a multiple line. That is, it is determined as a single line and not a multiple line. The determination range may be set as appropriate based on the multiple lines that exist in the driving region.

Next, the demarcation line recognition device 30 determines whether there is a candidate line affected by backlighting and whether the candidate line constitutes a part of a multiple line (step S50). As a result, when there is such a candidate line among the candidate lines (YES at step S50), the demarcation line recognition device 30 proceeds to step S60. On the other hand, when there is no such candidate line among the candidate lines (NO at step S50), the demarcation line recognition device 30 proceeds to step S80.

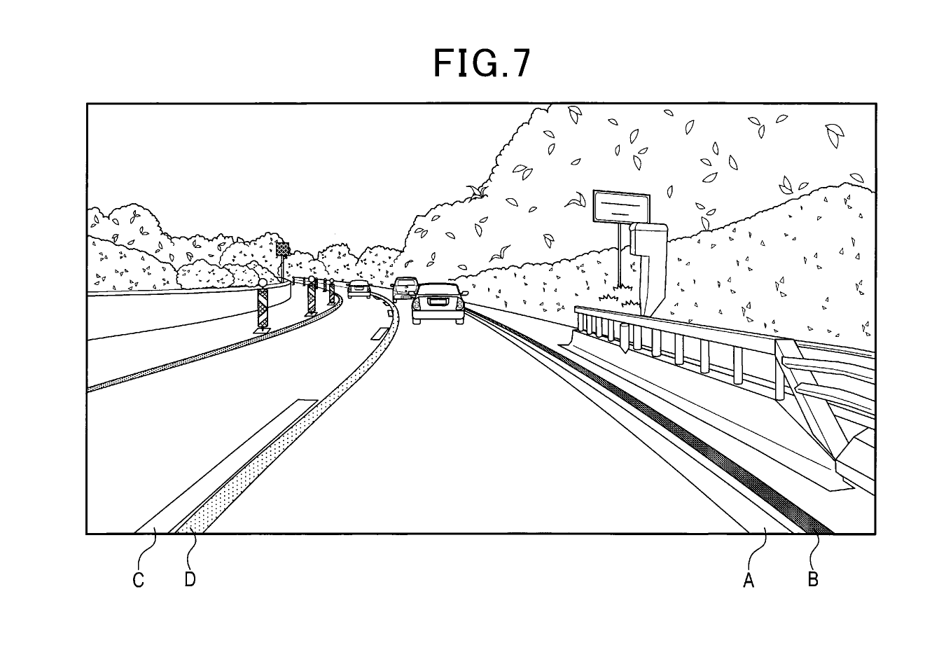

When it is determined that the candidate line under the influence of backlighting constitutes a part of a multiple line (YES at step S50), the demarcation line recognition device 30 executes the following process. Specifically, the demarcation line recognition device 30 compares the color information of candidate lines constituting a multiple line with each other and reperforms the determination of the line colors of the candidate lines (step S60). This will be explained using the image shown in FIG. 7 as an example. FIG. 7 shows an example road surface image captured by the in-vehicle camera 10. The road surface image shown in FIG. 7 is an example image of a scene in which a yellow line looks like a white line due to reflection of backlight. From this road surface image, candidate lines A to D are extracted by the candidate line extraction unit 34. In the extraction result at this time, the candidate lines A and C are white lines and the candidate lines B and D are yellow lines. FIG. 8 shows examples of the line type, line color, Y value (yellow component value), R value, G value, B value of the candidate lines A to D extracted from the image of FIG. 7. Note that the line color is the color determined by the process of step S20. The Y value is a value calculated from the R value, the G value, and the B value.

Here, the Y value is calculated by subtracting the B value from the R value (R value−B value). However, taking into consideration the fact that the entire image may be reddish or bluish, in the present embodiment, the R value and the B value are corrected. Specifically, in the present embodiment, the Y value is calculated as follows. Expressing the average value of the R values of the entire image as average R value, the average value of the G values of the entire image as average G value, and the average value of the B values of the entire image as average B value, the Y value is calculated using the following Eq.[1].

Y value=R value * (average G value/average R value)−B value * (average G value/average B value) [1]

The multiplication in the parenthesis shown in the above Eq. [1] corresponds to the correction of the R value and the B value described above.

In the example image of FIG. 7, the candidate lines C and D are the examples of backlight reflection. The candidate line C is originally white, and is determined to be white even under the influence of backlight. On the other hand, the candidate line D is originally yellow, but is determined to be white under the influence of backlight. In such a scene, comparing the candidate line D which is essentially yellow with the yellow candidate line B not affected by backlight, it can be seen that the differences between the R value, G value, and B value of the candidate line D are small due to the influence of backlight (see FIG. 8). That is, since the candidate line D is affected by backlight, the appearance ratio of the yellow characteristics in the color information decreases and the appearance ratio of the white characteristics increases. Therefore, although the candidate line D is essentially yellow, it is determined to be white.

The present inventor realized that, even when the appearance ratio of the yellow characteristics decreases in the color information of the candidate line that is essentially yellow due to the influence of backlight, the appearance ratio of the yellow characteristics is relatively large as compared with the color information of candidate lines that are not yellow. In view of this, in the present embodiment, the color information of the yellow candidate line D under the influence of backlight is compared with the color information of the white candidate line C, and the line colors of the candidate line D and the candidate line C are re-determined.

Specifically, the demarcation line recognition device 30 compares the Y values (yellow component values) of the candidate line D and the candidate line C. In addition, the demarcation line recognition device 30 compares the relationships of the magnitudes of the RGB component values. As shown in FIG. 8, the relationship of the magnitudes of the RGB component values of the candidate line C is G value>R value>B value, which does not correspond to the relationship of yellow (R value>G value>B value, or R value>G value and R value>B value). Further, the Y value of the candidate line C is much smaller than the Y values (for example, the Y value of the candidate line B) that yellow lines not affected by backlight may take. Therefore, the demarcation line recognition device 30 determines that the line color of the candidate line C is not yellow.

On the other hand, as shown in FIG. 8, the differences between the RGB component values of the candidate line D are small. The relationship of the magnitudes of the RGB component values of the candidate line D is R value>G value>B value, which corresponds to the relationship of yellow. Further, the Y value of the candidate line D is smaller than the Y values that yellow lines not affected by backlight may take. However, when compared with the Y value of the candidate line C whose color is not yellow, the value is sufficiently large. Thus, when the difference between the Y value of the candidate line D and the Y value of the candidate line C is larger than a preset yellow threshold, the demarcation line recognition device 30 determines that the line color of the candidate line D is yellow. Alternatively, when the ratio between the Y value of the candidate line D and the Y value of the candidate line C is larger than a predetermined threshold, the demarcation line recognition device 30 determines that the line color of the candidate line D is yellow. Then, when it is sufficient to consider yellow and white as the line colors, the demarcation line recognition device 30 determines that the line color of the candidate line C is white. Further, when there is a need to consider blue for the line color, the demarcation line recognition device 30 further checks whether the relationship of the magnitudes of the RGB component values of the candidate line C indicates the relationship of blue. The demarcation line recognition device 30 can compare the B value of the candidate line C with the B value of the candidate line D to determine whether the candidate line C is white or blue.

Next, the demarcation line recognition device 30 selects a candidate line corresponding to a demarcation line of the lane on which the vehicle 70 travels according to the rules of the driving region (step S70). Specifically, the demarcation line recognition device 30 uses the determination results (the line type and line color of each candidate line) obtained from the processes of steps S10, S20 and the determination result obtained from the process of step S40 (whether the candidate line constitutes a part of a multiple line). The demarcation line recognition device 30 selects a candidate line according to the rules of the driving region using these determination results. After that, the demarcation line recognition device 30 proceeds of step S110.

Further, when it is determined that the candidate line is not affected by backlight or does not constitute a part of a multiple line (NO at step S50), the demarcation line recognition device 30 is configured such that the candidate selection unit 37 selects a candidate line (step S80). That is, the demarcation line recognition device 30 carries out a process that is similar to that of step S70 to select a candidate line corresponding to a demarcation line of the lane on which the vehicle 70 travels, and then proceeds to step S90. The demarcation line recognition device 30 determines whether or not the candidate line selected by the process of step S80 is determined to be affected by backlight by the process of step S30 (step S90). When the candidate line selected by the process of step S80 has been determined to be affected by backlight (YES at step S90), the demarcation line recognition device 30 proceeds to step S100. On the other hand, when selected candidate line has not been determined to be affected by backlight (NO at step

S90), the demarcation line recognition device 30 proceeds to step S110.

The demarcation line recognition device 30 re-determines the line color of the candidate line selected by the process of step S80 and determined to be affected by backlight (step S100). That is, the demarcation line recognition device 30 carries out a process similar to that of step S60. Specifically, the demarcation line recognition device 30 compares the color information of two candidate lines selected by the process of step S80 with each other and re-determines the line color of the candidate line. The selected candidate line at this stage does not constitute a part of a multiple line. Thus, the demarcation line recognition device 30 compares the color information of two selected candidate lines that are located on the left and right of the vehicle 70 and re-determines the line color of the candidate line. It should be noted that, since the candidate line to be processed in step S100 does not constitute a part of a multiple line, even if the color determination of this candidate line was incorrect in the process of step S20, there is no problem in the selection of the candidate line by the process of step S80. However, depending on the color of the demarcation line, the control of the vehicle 70 may change. Therefore, in the present embodiment, the line color of the candidate line is re-determined to be used for controlling the vehicle 70.

Next, the demarcation line recognition device 30 recognizes the candidate line selected by the process of step S70 or S80 and estimates the shape of the lane on which the vehicle 70 travels (step S110). Specifically, the demarcation line recognition device 30 estimates demarcation line parameters such as the offset, yaw angle, curvature, lane width, pitch angle, etc. from the selected candidate line.

Next, the demarcation line recognition device 30 outputs, to the vehicle control device 50, the estimation results on the lane obtained from the process of step S110, and the line color of the candidate line selected by the process of step S70 or S80 (step S120). The vehicle control device 50 can thus execute the driving support of the vehicle 70 using the lane estimation results and the line color of the selected candidate line. The demarcation line recognition device 30 then ends the process.

In the present embodiment, the processes in steps S10 to S30, S60, and S100 correspond to processes executed by the line feature determination unit 35. The process in step S40 corresponds to a process executed by the multiple line determination unit 36. The processes in steps S70 and S80 correspond to processes executed by the candidate selection unit 37. The process in step S110 corresponds to a process executed by the lane estimation unit 38. The process in step S120 corresponds to a process executed by the output unit 39.

<3. Effects>

According to the present embodiment described above, the following effects can be obtained.

(1) When a candidate line under the influence of backlight constitutes a part of a multiple line, the demarcation line recognition device 30 compares the color information of candidate lines constituting the multiple line with each other and re-determines the line colors of the candidate lines. Thus, the demarcation line recognition device 30 can accurately determine the color of the candidate line and accurately estimate the lane even in a backlit scene.

(2) When a candidate line under the influence of backlight is included in candidate lines selected as demarcation lines located on the left and right of the vehicle 70, the demarcation line recognition device 30 compares the color information of the selected candidate lines with each other and re-determines the line color. Thus, the demarcation line recognition device 30 can accurately determine the color of the candidate line recognized as a demarcation line of a lane even in a backlit scene.

(3) The demarcation line recognition device 30 also outputs the line color of a demarcation line in addition to the estimation results on the lane shape. Thus, the vehicle control device 50 can use the line color of a demarcation line for driving support.

(4) The relationship of the RGB component values is determined based on the specific color of the demarcation line. In addition, even when a candidate line of a specific color is affected by backlight and white characteristics appear in the color information of the candidate line of the specific color, when comparing with the color information of candidate lines with colors other than the specific color, the color component value of the specific color appears large and also the characteristics of the specific color appear in the relationship of the RGB component values in the color information of the candidate line of the specific color. Thus, the demarcation line recognition device 30 compares candidate lines corresponding to specific colors with each other by their color component values and their relationships of the magnitudes of the RGB component values. As a result, the demarcation line recognition device 30 can accurately determine the line color of a candidate line under the influence of backlight.

(5) The luminance value of a part of a candidate line affected by backlight is much larger than those of the other parts. Thus, the demarcation line recognition device 30 can determine the presence or absence of the influence of backlight based on the luminance value of the candidate line. The demarcation line recognition device 30 can also determine the presence or absence of the influence of backlight based on the position of the light source with respect to the in-vehicle camera 10.

### Other Embodiments

An embodiment for implementing the technique of the present disclosure has been described above, but the technique of the present disclosure is not limited to the above-described embodiment. For example, the technique of the present disclosure can be implemented with various modifications as described below.

(a) In the demarcation line recognition device 30 of the above embodiment, in the process of step S20 performed by the line feature determination unit 35, the color other than white, i.e., yellow or blue is determined based on the relationship of the magnitudes of the RGB component values. The technique of the present disclosure is not limited to this. For example, the line feature determination unit 35 may determine that the line color is yellow or blue when the color component value of yellow or blue is larger than a preset threshold.

(b) The line color of a demarcation line is not limited to one of white, yellow, and blue.

The line color may be another specific color such as red, for example. In that case, the demarcation line recognition device 30 can determine whether the candidate line is a specific color as in the case of yellow.

(c) In the above embodiment, the color space of the color image of the road surface is RGB. The technique of the present disclosure is not limited to this. The color space of the image may be any color space if candidate lines can be extracted from the image, and the line type, the line color, and the presence or absence of the influence of backlight of the extracted candidate lines can be determined as described above.

(d) A plurality of functions possessed by a single element in the above embodiment may be realized by a plurality of elements. A single function possessed by a single element may be realized by a plurality of elements. A plurality of functions possessed by a plurality of elements may be realized by a single element. A single function realized by a plurality of elements may be realized by a single element. Further, a part of the configuration of the above embodiment may be omitted. Furthermore, at least a part of the configuration of the above embodiment may be added or substituted in the configuration of the other embodiments described above. The embodiments of the technique according to the present disclosure include various modes included in the technical scope determined by the language of the claims, without departing from the scope of the present disclosure.

(e) The technique of the present disclosure can be realized by various forms such as the following system, program, computer readable storage medium, method, etc., in addition to the demarcation line recognition device 30 described above. Specifically, the system is a system including the demarcation line recognition device 30 as a component. The program is a program for causing a computer to function as the demarcation line recognition device 30. The storage medium is a non-transitory computer-readable storage medium such as a semiconductor memory in which the program is stored. The method is a lane estimation method for recognizing a demarcation line and estimating a lane.

What is claimed is:

1. A demarcation line recognition device for estimating a lane on which a vehicle travels from a color road surface image taken by a camera, the device comprising:
a candidate line extraction unit configured to extract a candidate line which is a candidate for a demarcation line demarcating the lane from the road surface image;
a line feature determination unit configured to determine a line type and a line color of the candidate line extracted by the candidate line extracting unit, and presence or absence of an influence of backlight, the backlight being light from a direction opposing the camera;
a multiple line determination unit configured to determine whether the candidate line extracted by the candidate line extraction unit constitutes a part of a multiple line;
a candidate selection unit configured to select the candidate line corresponding to the demarcation line from the candidate lines extracted by the candidate line extraction unit, using the line type and the line color determined by the line feature determination unit, and the determination result of the multiple line determination unit, and according to rules of a driving region;
a lane estimation unit configured to recognize the candidate line selected by the candidate selection unit and estimate a shape of the lane; and
an output unit configured to output the estimation result estimated by the lane estimation unit, wherein
when the candidate line determined to be under the influence of the backlight constitutes a part of the multiple line, the line feature determination unit compares color information of the candidate lines constituting that multiple line with each other and re-determines the line color of the candidate line determined to be under the influence of the backlight.

2. The demarcation line recognition device according to claim 1, wherein
when a candidate line determined to be under the influence of the backlight is included in the candidate lines selected by the candidate selection unit as demarcation lines located on the left and right of the vehicle, the line feature determination unit compares color information of the selected candidate lines with each other and re-determines the line color of the candidate line determined to be under the influence of the backlight, and
the output unit is configured to further output the line color determined by the line feature determination unit of the candidate line selected by the candidate selection unit.

3. The demarcation line recognition device according to claim 1, wherein
upon re-determination of the line color, the line feature determination unit is configured to re-determine the line color by comparing the candidate lines with each other by their color component values of the candidate lines corresponding to a specific color of the demarcation line, and their relationships of the component values of a color space of the candidate lines.

4. The demarcation line recognition device according to claim 1, wherein
the line feature determination unit is configured to determine presence or absence of the influence of the backlight on the candidate line based on at least one of a luminance value of the candidate line and a position of a light source with respect to the camera.
